(19) United States
(12) Patent Application Publication
(10) Pub. No.: US 2007/0247407 A1
(43) Pub. Date: Oct. 25, 2007

(54) Gamma adjusting apparatus and method of the same

(75) Inventors: Hsin-Hung Lee, Fongshan City (TW); Tung-Lin Hsieh, Jhongli City (TW); Yung-Sheng Hsu, Kaohsiung City (TW)

Correspondence Address: THE LAW OFFICES OF ANDREW D. FORTNEY, PH.D., P.C., 401 W FALLBROOK AVE STE 204, FRESNO, CA, 93711-5835, US

(73) Assignee: Quanta Computer Inc.

(21) Appl. No.: 11/716,111

(22) Filed: Mar. 8, 2007

(30) Foreign Application Priority Data
Apr. 19, 2006 (TW) 095113873

(51) Int. Cl. G09G 3/36

(52) U.S. Cl. 345/89

(57) ABSTRACT

The invention discloses a gamma adjusting apparatus for adjusting the gray level of each pixel of an image signal. The gamma adjusting apparatus includes a measuring unit, a first processing unit, a second processing unit, and a third processing unit. The measuring unit measures the lightness of N reference gray levels. The first processing unit normalizes the lightness of the N reference gray levels to generate N normalized reference values. The second processing unit compares the N normalized reference values with a standard gamma curve to generate N adjusted gray levels. According to the N reference gray levels and the N adjusted gray levels, the third processing unit sets an adjusting rule. According to the adjusting rule, the gamma adjusting apparatus is capable of adjusting the gray level of each pixel of the image signal to comply with the standard gamma curve.

### BACKGROUND OF THE INVENTION

1. Field of the Invention

The invention relates to a gamma adjusting apparatus and method, and more particularly, to a gamma adjusting apparatus and method capable of effectively improving the gamma characteristic of a flat panel display (FPD).

2. Description of the Prior Art

Because the fluorescent characteristic of conventional cathode ray tube (CRT) complies with gamma 2.2, the image signal has to comply with gamma 0.45 for display, and then the displayed image will comply with gamma 1.0 consequently. Nowadays, since the image signal inputted to the FDP complies with gamma 0.45, the gamma characteristic of the FDP has to be converted into gamma 2.2 to match up with the image signal.

In general, it is quite important to adjust the gamma value to be a constant, so that the colors displayed on the screen can maintain consistency. Unstable gamma value not only cannot guarantee consistent colors between equipment and equipment but also cannot maintain stable colors. Therefore, for a good screen, the gamma value should be maintained as a constant, and the screen should be stable enough to maintain the gamma value. Accordingly, the colors displayed on the screen will maintain consistency.

For liquid crystal display (LCD) panel, the gamma value may be influenced by resistance, back light component, the fabricating process, and so on. The scope of the invention is to provide a gamma adjusting apparatus and method for improving voltage difference, so as to solve the aforementioned problems.

### SUMMARY OF THE INVENTION

A scope of the invention is to provide a gamma adjusting apparatus and method for adjusting the gamma characteristic of the panel without changing the resistance of the hardware.

According to a preferred embodiment, the gamma adjusting apparatus of the invention is used for adjusting the gray level of each pixel of an image signal. The gamma adjusting apparatus comprises a measuring unit, a first processing unit, a second processing unit, and a third processing unit.

The measuring unit is used for measuring lightness of N reference gray levels, wherein N is a natural number. The first processing unit is used for normalizing the lightness of the N reference gray levels to generate N normalized reference values corresponding to the N reference gray levels. The second processing unit is used for comparing the N normalized reference values with a standard gamma curve to generate N adjusting gray levels corresponding to the N reference gray levels. The third processing unit is used for setting an adjusting rule according to the N reference gray levels and the N adjusting gray levels. When the pixels of the image signal are inputted into the gamma adjusting apparatus, the gamma adjusting apparatus will adjust the gray level of each pixel to comply with the standard gamma curve according to the adjusting rule.

Therefore, the gamma adjusting apparatus of the invention only has to measure the lightness of specific reference gray levels and then compare those reference gray levels with the standard gamma curve, such that the image signal can be adjusted to comply with gamma characteristic of the panel. Consequently, the adjusting rate of gamma is improved.

The advantage and spirit of the invention may be understood by the following recitations together with the appended drawings.

### BRIEF DESCRIPTION OF THE APPENDED DRAWINGS

FIG. 1 is a functional block diagram illustrating a display system.

FIG. 2 is a functional block diagram illustrating a gamma adjusting apparatus according to a preferred embodiment of the invention.

FIG. 3 illustrates the reference gray levels defined by Novatek.

FIG. 4 illustrates the result after the image signal is adjusted by the invention.

FIG. 5 is a flowchart showing the gamma adjusting method according to a preferred embodiment of the invention.

### DETAILED DESCRIPTION OF THE INVENTION

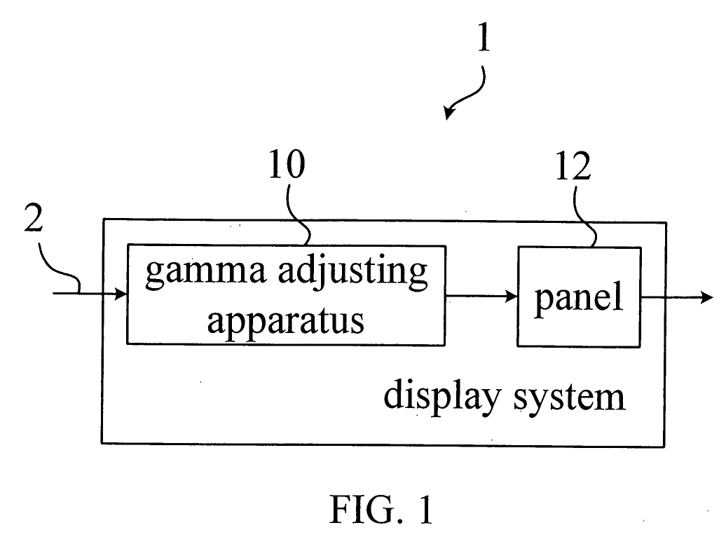

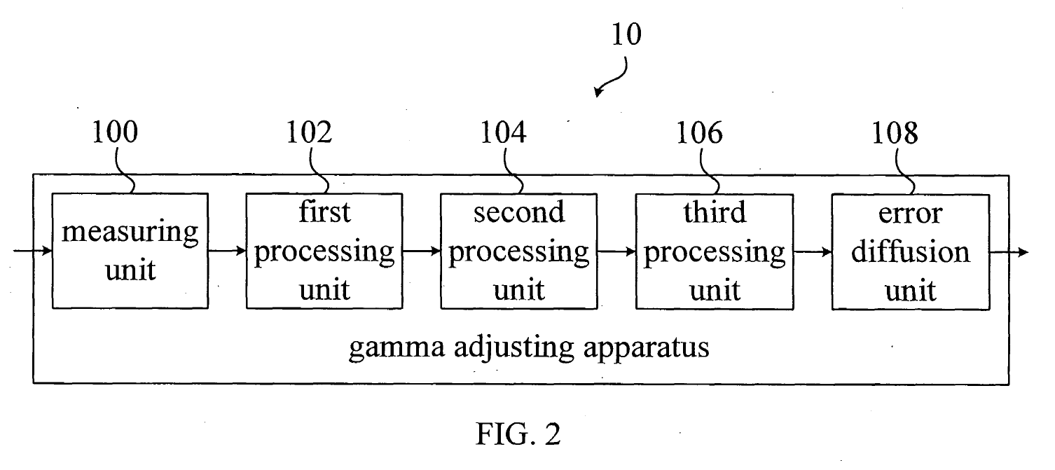

Referring to FIG. 1 and FIG. 2, FIG. 1 is a functional block diagram illustrating a display system 1, and FIG. 2 is a functional block diagram illustrating a gamma adjusting apparatus 10 according to a preferred embodiment of the invention. The invention provides the gamma adjusting apparatus 10 for adjusting the gray level of each pixel of an image signal 2 within the display system 1 to comply with gamma characteristic of the panel 12. In this embodiment, the display system 1 can be an FDP, such as plasma display panel (PDP), LCD, and so on. Take PDP as an example, the drive ICs can be divided into data IC and gate IC, wherein the gate IC is used for checking whether the signals on the PDP is on/off, and the data IC is used for inputting related image data.

As shown in FIG. 2, the gamma adjusting apparatus 10 comprises a measuring unit 100, a first processing unit 102, a second processing unit 104, a third processing unit 106, and an error diffusion unit 108.

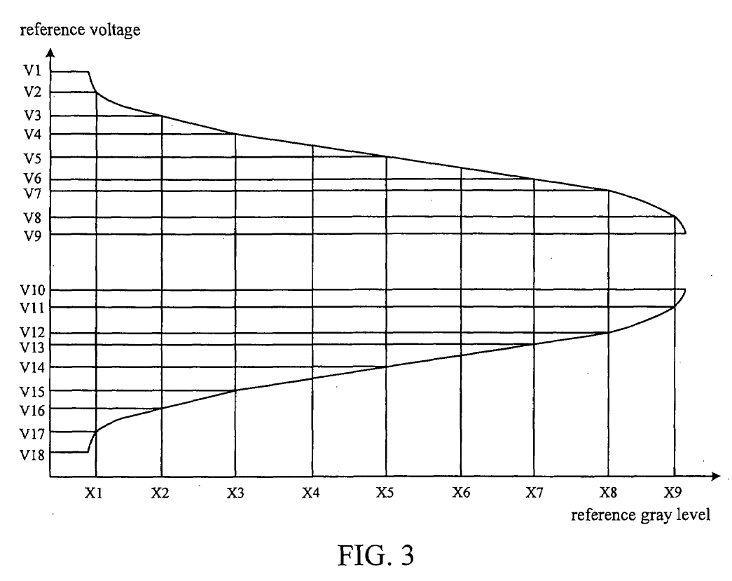

The measuring unit 100 is used for measuring the lightness of N reference gray levels, wherein N is a natural number. The reference gray levels are defined by the data IC. Referring to FIG. 3, FIG. 3 illustrates the reference gray levels defined by Novatek. As shown in FIG. 3, X1-X9 represent the reference gray levels, and each of the reference gray levels X1-X9 respectively corresponds to one of the reference voltage V1-V9 with positive-polarity and one of the reference voltage V10-V18 with negative-polarity. The invention will be depicted in the following in accordance with the reference gray levels defined by Novatek, but not limited to that manner.

In this embodiment, the lightness of each reference gray level X1-X9 measured by the measuring unit 100 is listed in table 1 as follows.

TABLE 1

| Reference gray level | Lightness |
|---|---|
| 1 (X1) | 0.53 (L1) |
| 32 (X2) | 7.48 (L2) |
| 64 (X3) | 29.42 (L3) |
| 96 (X4) | 75.21 (L4) |
| 128 (X5) | 135 (L5) |
| 160 (X6) | 214.1 (L6) |
| 192 (X7) | 310.2 (L7) |
| 224 (X8) | 422.8 (L8) |
| 254 (X9) | 548.3 (L9) |

In this embodiment, the first processing unit 102 is coupled to the measuring unit 100. According to equation 1 below, the first processing unit 102 is used for normalizing the lightness of the reference gray levels X1-X9 to generate nine normalized reference values corresponding to the reference gray levels X1-X9.

$$Equation 1 \text{:}$$

$$Nor\_Ln = \frac{L n - L 1}{L 9 - L 1} .$$

In equation 1, Ln represents the lightness of the n^{th} reference gray level, Nor_Ln represents the n^{th} normalized reference value. The nine normalized reference values corresponding to the reference gray levels X1-X9 are listed in table 2 as follows.

TABLE 2

| Reference gray | | Normalized reference |
|---|---|---|
| level | Lightness | value |
| 1 (X1) | 0.53 (L1) | 0 (Nor_L1) |
| 32 (X2) | 7.48 (L2) | 0.012688 (Nor_L2) |
| 64 (X3) | 29.42 (L3) | 0.052741 (Nor_L3) |
| 96 (X4) | 75.21 (L4) | 0.136335 (Nor_L4) |
| 128 (X5) | 135 (L5) | 0.245486 (Nor_L5) |
| 160 (X6) | 214.1 (L6) | 0.38989 (Nor_L6) |
| 192 (X7) | 310.2 (L7) | 0.565329 (Nor_L7) |
| 224 (X8) | 422.8 (L8) | 0.770889 (Nor_L8) |
| 254 (X9) | 548.3 (L9) | 1 (Nor_L9) |

In this embodiment, the second processing unit 104 is coupled to the first processing unit 102 and is used for comparing the nine normalized reference values with a standard gamma curve to generate nine adjusting gray levels corresponding to the reference gray levels X1-X9. The standard gamma curve can be generated by equation 2 as follows.

$$Equation 2 \text{:}$$

$${( \frac{x}{255} )}^{δ} .$$

For example, if the gamma characteristic of the panel 12 is gamma 2.2, δ in equation 2 will be equal to 2.2. In equation 2, x represents any of the gray levels. The invention will be depicted in the following in accordance with gamma 2.2, but not limited to that manner. For example, if the normalized reference value corresponding to the reference gray level 32 (X2) is equal to 0.012688 (Nor_L2), the corresponding value of gamma 2.2 is equal to 0.012664 (x=35); if the normalized reference value corresponding to the reference gray level 64 (X3) is equal to 0.052741 (Nor_L3), the corresponding value of gamma 2.2 is equal to 0.052842 (x=67); and so on. The nine adjusting gray levels (Y1-Y9) corresponding to the reference gray levels X1-X9 are listed in table 3 as follows.

TABLE 3

| Reference gray level | Adjusting gray level |
|---|---|
| 1 (X1) | 1 (Y1) |
| 32 (X2) | 35 (Y2) |
| 64 (X3) | 67 (Y3) |
| 96 (X4) | 103 (Y4) |
| 128 (X5) | 135 (Y5) |
| 160 (X6) | 166 (Y6) |
| 192 (X7) | 197 (Y7) |
| 224 (X8) | 227 (Y8) |
| 254 (X9) | 254 (Y9) |

In this embodiment, the third processing unit 106 is coupled to the second processing unit 104. According to the aforesaid nine reference gray levels (X1-X9) and adjusting gray levels (Y1-Y9), the third processing unit 106 is used for setting an adjusting rule. The adjusting rule comprises the following formulae:

when Gᵢₙ is equal to 0 or 255, Gₒᵤₜ is equal to Gᵢₙ; and

when Gᵢₙ is larger than or equal to Yᵢ and Gᵢₙ is smaller than Yᵢ₊₁,

$${G}_{out} = ( {G}_{i n} - {Y}_{i} ) * ( \frac{{X}_{i + 1} - {X}_{i}}{{Y}_{i + 1} - {Y}_{i}} ) + {Y}_{i} ,$$

wherein i is an integer index between 1 and N−1.

In the aforesaid adjusting rule, Gᵢₙ represents the gray level of each pixel, Gₒᵤₜ represents the adjusted gray level of each pixel, Xᵢ represents the i^{th} reference gray level of the nine reference gray levels (X1-X9), and Yᵢ represents the i^{th} adjusting gray level of the nine adjusting gray levels (Y1-Y9). When the image signal 2 is inputted into the gamma adjusting apparatus 10 of the display system 1, the gamma adjusting apparatus 10 will adjust the gray level Gᵢₙ of each pixel of the image signal 2 to the gray level Gₒᵤₜ complying with the gamma curve (e.g. gamma 2.2 in this embodiment) according to the aforesaid adjusting rule.

For example, if the gray level Gᵢₙ of one pixel is equal to 35, the adjusted gray level Gₒᵤₜ is equal to 32. Since the gamma characteristic of the panel 12 is gamma 2.2, the adjusted gray level (Gₒᵤₜ=32) can be accurately displayed on the panel 12 by the lightness of gray level 35.

In another preferred embodiment of the invention, a look-up table can be set based on the aforesaid adjusting rule. The look-up table records a plurality of input gray levels Gᵢₙ and a plurality of output gray levels Gₒᵤₜ, and each of the output gray levels Gₒᵤₜ respectively corresponds to one of the input gray levels Gᵢₙ, as shown in the following table 4.

TABLE 4

| Output gray level Gₒᵤₜ | Input gray level Gᵢₙ |
|---|---|
| 0 | 0 |
| 1 | 1 |
| 1.911765 | 2 |
| 2.823529 | 3 |
| . . . | . . . |
| 32 | 35 |
| 36 | 36 |
| . . . | . . . |
| 64 | 67 |
| 67.888889 | 68 |
| . . . | . . . |
| 255 | 255 |

Finally, after the image signal 2 is adjusted, the error diffusion unit 108, coupled to the third processing unit 106, diffuses variation error (decimal) of each pixel. Accordingly, the adjusted image signal 2 can be accurately displayed on the panel 12 by the lightness complying with the gamma characteristic of the panel 12.

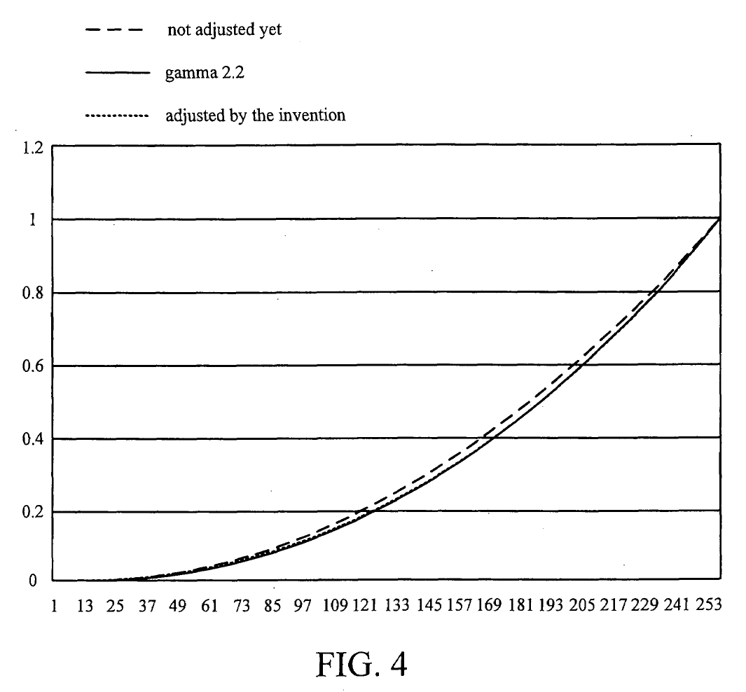

Referring to FIG. 4, FIG. 4 illustrates the result after the image signal is adjusted by the invention. As shown in FIG. 4, it is obvious that after being adjusted by the invention, the image signal almost completely complies with the standard gamma 2.2 curve.

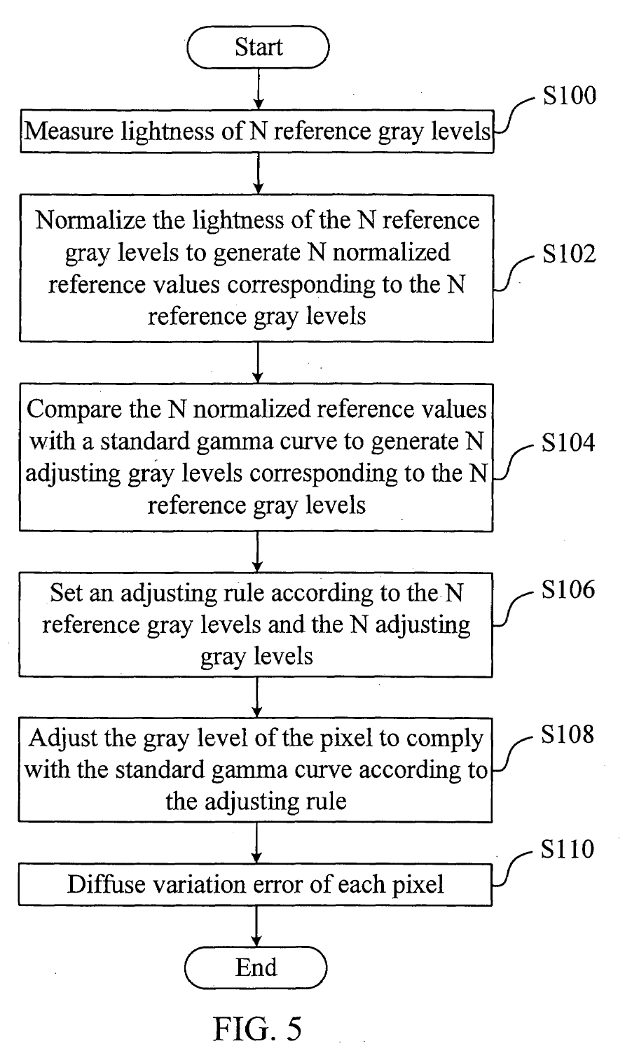

Referring to FIG. 5, FIG. 5 is a flowchart showing the gamma adjusting method according to a preferred embodiment of the invention. Referring to FIG. 1 to FIG. 3, the method of the invention is used for adjusting the gray level of each pixel of the image signal 2 within the display system 1 to comply with the gamma characteristic of the panel 12. According to the aforesaid preferred embodiment, the gamma adjusting method of the invention comprises the following steps.

At the start, step S100 is performed to measure the lightness of N reference gray levels (N is equal to 9 defined by Novatek). Afterward, step S102 is performed to normalize the lightness of the N reference gray levels to generate N normalized reference values corresponding to the N reference gray levels. Step S104 is then performed to compare the N normalized reference values with a standard gamma curve to generate N adjusting gray levels corresponding to the N reference gray levels. Step S106 is then performed to set an adjusting rule according to the N reference gray levels and the N adjusting gray levels. Step S108 is then performed to adjust the gray level of the pixel to comply with the standard gamma curve according to the adjusting rule. Finally, step S110 is performed to diffuse variation error (decimal) of each pixel.

Compared to the prior art, the gamma adjusting apparatus and method of the invention only have to measure the lightness of specific reference gray levels defined by the data IC and then compare those reference gray levels with the standard gamma curve (in light of the gamma characteristic of the panel), such that the image signal can be adjusted to comply with the gamma characteristic of the panel. Consequently, the adjusting rate of gamma is improved.

With the example and explanations above, the features and spirits of the invention will be hopefully well described. Those skilled in the art will readily observe that numerous modifications and alterations of the device may be made while retaining the teaching of the invention. Accordingly, the above disclosure should be construed as limited only by the metes and bounds of the appended claims.

What is claimed is:

1. A gamma adjusting apparatus for adjusting a gray level of a pixel, the apparatus comprising:
a measuring unit for measuring the lightness of N reference gray levels, N being a natural number;
a first processing unit, coupled to the measuring unit, for normalizing the lightness of the N reference gray levels to generate N normalized reference values corresponding to the N reference gray levels;
a second processing unit, coupled to the first processing unit, for comparing the N normalized reference values with a standard gamma curve to generate N adjusting gray levels corresponding to the N reference gray levels; and
a third processing unit, coupled to the second processing unit, for setting an adjusting rule according to the N reference gray levels and the N adjusting gray levels;
wherein when the pixel is inputted into the gamma adjusting apparatus, the gamma adjusting apparatus adjusts the gray level of the pixel to comply with the standard gamma curve according to the adjusting rule.

2. The apparatus of claim 1, wherein the adjusting rule comprises the following formulae:
when Gᵢₙ is equal to 0 or 255, Gₒᵤₜ is equal to Gᵢₙ; and
when Gᵢₙ is larger than or equal to Yᵢ and Gᵢₙ is smaller than Yᵢ₊₁,
$${G}_{out} = ( {G}_{i n} - {Y}_{i} ) * ( \frac{{X}_{i + 1} - {X}_{i}}{{Y}_{i + 1} - {Y}_{i}} ) + {Y}_{i} ,$$
i is an integer index between 1 and N−1;
wherein Gᵢₙ represents the gray level of the pixel, Gₒᵤₜ represents the adjusted gray level of the pixel, Xᵢ represents the i^{th} reference gray level of the N reference gray levels, and Yᵢ represents the i^{th} adjusting gray level of the N adjusting gray levels.

3. The apparatus of claim 1, wherein the adjusting rule is a look-up table recording a plurality of input gray levels and a plurality of output gray levels, each of the output gray levels respectively corresponds to one of the input gray levels, the gray level of the pixel belongs to the input gray levels, and the adjusted gray level of the pixel belongs to the output gray levels.

4. The apparatus of claim 3, wherein the look-up table is set based on the following formulae:
when Gᵢₙ is equal to 0 or 255, Gₒᵤₜ is equal to Gᵢₙ; and
when Gᵢₙ is larger than or equal to Yᵢ and Gᵢₙ is smaller than Yᵢ₊₁,
$${G}_{out} = ( {G}_{i n} - {Y}_{i} ) * ( \frac{{X}_{i + 1} - {X}_{i}}{{Y}_{i + 1} - {Y}_{i}} ) + {Y}_{i} ,$$
i is an integer index between 1 and N−1;
wherein Gᵢₙ represents the input gray level, Gₒᵤₜ represents the output gray level, Xᵢ represents the i^{th} reference gray level of the N reference gray levels, and Yᵢ represents the i^{th} adjusting gray level of the N adjusting gray levels.

5. The apparatus of claim 1, further comprising an error diffusion unit, coupled to the third processing unit, for diffusing the variation error after the pixel is adjusted.

6. The apparatus of claim 1, wherein the N reference gray levels are defined by a data IC.

7. A gamma adjusting method for adjusting a gray level of a pixel, the method comprising steps of:
(a) measuring the lightness of N reference gray levels, N being a natural number;
(b) normalizing the lightness of the N reference gray levels to generate N normalized reference values corresponding to the N reference gray levels;
(c) comparing the N normalized reference values with a standard gamma curve to generate N adjusting gray levels corresponding to the N reference gray levels; and
(d) setting an adjusting rule according to the N reference gray levels and the N adjusting gray levels;
(e) adjusting the gray level of the pixel to comply with the standard gamma curve according to the adjusting rule.

8. The method of claim 7, wherein the adjusting rule comprises the following formulae:
when Gᵢₙ is equal to 0 or 255, Gₒᵤₜ is equal to Gᵢₙ; and
when Gᵢₙ is larger than or equal to Yᵢ and Gᵢₙ is smaller than Yᵢ₊₁,
$${G}_{out} = ( {G}_{i n} - {Y}_{i} ) * ( \frac{{X}_{i + 1} - {X}_{i}}{{Y}_{i + 1} - {Y}_{i}} ) + {Y}_{i} ,$$
i is an integer index between 1 and N−1;
wherein Gᵢₙ represents the gray level of the pixel, Gₒᵤₜ represents the adjusted gray level of the pixel, Xᵢ represents the i^{th} reference gray level of the N reference gray levels, and Yᵢ represents the i^{th} adjusting gray level of the N adjusting gray levels.

9. The method of claim 7, wherein the adjusting rule is a look-up table recording a plurality of input gray levels and a plurality of output gray levels, each of the output gray levels respectively corresponds to one of the input gray levels, the gray level of the pixel belongs to the input gray levels, and the adjusted gray level of the pixel belongs to the output gray levels.

10. The method of claim 9, wherein the look-up table is set based on the following formulae:
when Gᵢₙ is equal to 0 or 255, Gₒᵤₜ is equal to Gᵢₙ; and
when Gᵢₙ is larger than or equal to Yᵢ and Gᵢₙ is smaller than Yᵢ₊₁,
$${G}_{out} = ( {G}_{i n} - {Y}_{i} ) * ( \frac{{X}_{i + 1} - {X}_{i}}{{Y}_{i + 1} - {Y}_{i}} ) + {Y}_{i} ,$$
i is an integer index between 1 and N−1;
wherein Gᵢₙ represents the input gray level, Gₒᵤₜ represents the output gray level, Xᵢ represents the i^{th} reference gray level of the N reference gray levels, and Yᵢ represents the i^{th} adjusting gray level of the N adjusting gray levels.

11. The method of claim 7, further comprising step of:
(f) diffusing the variation error after the pixel is adjusted.

12. The method of claim 7, wherein the N reference gray levels are defined by a data IC.
